(19) United States
(12) Patent Application Publication
(10) Pub. No.: US 2014/0115053 A1
(43) Pub. Date: Apr. 24, 2014

(54) METHOD OF FINDING MEMBERS OF THE SOCIAL MEDIA NETWORK

(71) Applicant: Alex Iosilevsky, San Francisco, CA (US)

(72) Inventor: Alex Iosilevsky, San Francisco, CA (US)

(21) Appl. No.: 13/655,728

(22) Filed: Oct. 19, 2012

(51) Int. Cl. G06F 15/16

(52) U.S. Cl. 709/204

(57) ABSTRACT

The invention relates to a method of finding members of the social media network having common interests and may find use in such social media as common interests, location, profession, age, rank, player skill, etc. The novelty of the method is that for the users the level of mutual interest is evaluated on a scale of 1 to 10, and the users are not exposed to each other and are not aware of the existence of each other until their interests coincide to a predetermined degree and they both agree to be exposed.

### FIELD OF THE INVENTION

The present invention relates to a method of finding members of the social media network having common interests, location, profession, age, etc. The invention may be used in such social media as a match-making group, a dating club, people of the same interests, people of the same specialty, people graduated from the same school or university, people united by the place of birth, etc.

### BACKGROUND OF THE INVENTION

Social media and mobile applications have increased connectivity between wider peer groups, enabling any given user to communicate with their inner and extended network of peers and friends on a 24-hour cycle, from anywhere in the world. With the use of GPS and other global positioning systems any given user can locate others and broadcast the user's own location to a personal preference network of peers, friends and family.

There exist a great variety of a social media networks and a method of communication between the members of the social media network where some degree of anonymity is maintained between the participants.

For example, U.S. Pat. No. 7,188,153 issued Mar. 6, 2007 to Lunt, et al. discloses a system and method for managing connections in an online social network. The online social network collects descriptive data about various individuals and allows those individuals to indicate other individuals with whom they have a personal relationship. The descriptive data and the relationship data are integrated and processed to reveal the series of social relationships connecting any two individuals within a social network. A maximum degree of separation setting is provided and set to at least two. The maximum degree of separation setting limits the amount of searching that is carried out when searching for a connection between two individuals in the social network. Users in the system have the ability to provide information about one another. For example, one user might write a positive comment about a second user's personality. In one implementation, the second user may accept or reject display of the comment. Further, in this implementation, any other users who are connected to the second user through any number of acquaintance pathways may see the comment as part of the “descriptive data” about the second user.

U.S. Pat. No. 7,117,254 issued Oct. 3, 2006 to Lunt, et al. discloses a method of inducing content uploads in an online network includes the steps of storing content relating to a first member of the network that is submitted by a second member of the network, receiving approval of the content from the first member, and associating the content with the first member. The uploaded content may comprise an image file containing a photo of the first member and a caption associated with the photo image. The second user uploads the content relating to the first member using a graphic user interface (GUI). This GUI is made available to the second user through a hyperlink that appears when a profile page of the first member is accessed if the degree of separation between the first member and the second member is less than or equal to a maximum degree of separation set by the first user. On the other hand, the hyperlink to this GUI will not appear when the profile page of the first member is accessed by the second member if the degree of separation between the first member and the second member is greater than the maximum degree of separation set by the first user. The default setting for this maximum degree of separation is one. US Patent Application publication No. 20090320101 published Dec. 24, 2009 (inventors: Doyle, III, et al.) discloses a system and method that authenticate the identity of the person behind a username and store that information in a manner that allows a first person communicating on a social network with a second person to confirm that the identity of the second person is known and authenticate without requiring the second person to reveal identity information (other than their user name/screen name) to the first person and vice versa.

US Patent Application Publication No. 20110299478 published Dec. 8, 2011 (Inventor: Clark) discloses a method for initiating communication between at least two users of two or more users operating communications devices, at least one of which is a cellular telephone device, on a local area network (LAN) connected to a cellular telephone network having gateway access to the Internet network, the communication advanced according to priority profile exchange and matching between the users. The method comprises (a) activating the communications devices to exchange profile information with each other; (b) receiving profiles, each communications device receiving profiles from other participating communications devices, including the cellular telephone receiving profiles from a Web server in the Internet; (c) comparing the received profiles to local profiles stored on each of the participating communications devices or on the Web server in the Internet network, the matching performed according to priority criteria; (d) registering at least one match of profiles on at least one of the communications devices or on the Web server; (e) identifying the sending device of the highest priority profile matched either at the local device or at the Web server; and (f) initiating text messaging communication between the communications devices involved in the profile match, the communication initiated from the device registering the profile match or by the Web server.

U.S. Pat. No. 8,209,310 issued Jun. 26, 2012 to Metcalfe discloses a professional networking system and method that facilitate a meeting between two or more users of the system for the purpose of expanding the users' professional networks. Users are matched by the system based on one or more available meeting dates of each user, and one or more sought characteristics corresponding to one or more characteristics of the second user that the first user profile seeks in another user. The system does not directly reveal the characteristics of one matched user to any other user except certain basic contact information may be disclosed to another matched user to facilitate a meeting.

Many other systems and methods similar to those described above exist in the art. In general, however, they do not provide a sufficient degree of anonymity and search for a colleague, mate, or interest-sharing individual anonymously and without the anxiety of rejection or the worry of offending another user.

### SUMMARY OF THE INVENTION

It is an object of the present invention to create a multi-user, multi-platform, social networking and mobile application which connects users drawn from a wide and extended social network, interest groups, and other. The present invention can employ the capabilities of geographical locations and positioning systems to create a real-time, real-world, application environment encouraging the social connectivity and communication between two or more separate users.

The purpose behind the application is multifaceted. Firstly, it is the present invention's intention to foster a safe and casual environment for the user to reach out and express various degrees of interest over other users. The user can reach out anonymously, without the anxiety of rejection or the worry of offending another user. Meanwhile the user, when indicating positive interest in another user, is not assured of a mutual positive response from the selected individual. An element of chance is retained in the application, which promotes a casual environment. If by separate choice, chance, or coincidence, the user's selected individual returns a mutual positive interest, then both parties will receive notice that a mutual match has been established. With the given consent of each user, their identities are revealed to each user exclusively. Their identities remain anonymous to the rest of their respective networks. Their course of events reached the climax. Each user can continue to repeat the process and express various levels of interest toward other users.

When a mutual positive connection is confirmed between the user and a selected party, then the choice to reveal the identity is allowed, and the two parties can assume communication inside or outside of the application environment. If the user or the selected party options to ignore or not respond to an expressed level of interest from another user, then the identities will be kept hidden and no harm or foul is performed.

What sets this application apart from other social network, dating, matching, and flirting sites is the degree of anonymity each user enjoys throughout the process. Another factor is that the individuals selected within their pool of friends, peers, and family remains within their inner and extended social network of peers, friends, and family, as well as interest groups, and other associations. This ensures that there is a limited number of degrees of separation from the user and other users within the application environment. A thread of familiarity can be enjoyed by all users.

The process can be repeated over and over, positive matches can be collected, and new ones explored and established through the entire application experience. As a user's network grows, so does the pool of individuals the application can draw from.

The present invention's mobile application features employ geographic positions systems to locate users within a user preset region or distance in relation to the current position of the mobile application initial user. A notice is sent to an active mobile user indicating that there may be other users within the region or proximity who may or may not have expressed levels of interest concerning the initial user. The mobile user can then select another user from a gallery group presented within the application environment. The user may then have an option to send out his or her own indications of levels of interest toward any selected user. The process repeats until a mutual positive match is identified, and the involved users can choose to drop their anonymity and choose to communicate inside or outside of the application environment.

Thus according to one aspect, the method of the invention for finding members of the social media network having the same interests can be summarized as follows: (a) providing the social media network with an account for the members, a general database, “not-interested” database, “may-be-interested” database, “is-interested” database, and a level of interest gradation unit, the social media network being preliminarily installed in the world net, the general database containing a limited information about the members of the social media network, the limited information making it impossible to identify the member; (b) checking if a person who is logging into the social media network has an account with the social media network; (c) checking through the account if the person satisfies the membership requirements; (d) loading into the general database of the social media network a limited information about the person who was accepted as a member to the social media network; (e) presenting to the person who was accepted as a member the limited information about the other members; (f) using said limited information by a person accepted as a member to the social media network for finding another member who has the same interests; (g) keeping the fact of searching confidential from all other members of the social network so that a member being sought is not aware of the search; (h) placing the “not-interested” information into the “not-interested” database, if the searching person is not interested in any of other members and keeping the “not-interested” information confidential; (i) choosing a level of interest from the interest gradation unit if the searching person is interested in another member of the social network and establishing a minimal difference of the grades at which the searching person and the person being sought are considered matched, the level of interest being kept confidential; (j) sending the chosen level of information to the general database and to the “may-be-interested” database where it is kept confidential from other members; (k) passing the person being sought through the steps (b) through (j) while keeping the procedures confidential for the searching person as well as for the other members of the social network; (l) comparing the level of interest of the searching person with the level of interest of the person being sought if the person being sought independently expresses his/her interest in the searching person, both persons still being unaware of the mutual interest, and the levels of interest being places into the “is-interested” database; (m) asking the searching person and the person being sought if they both agree to be exposed to each other, if the minimal difference of the grades is achieved; and (n) exposing the searching person to the person being sought if both these persons agrees to be connected.

### BRIEF DESCRIPTION OF THE DRAWINGS

FIG. 1A is a flow-chart that illustrates the sequence of events taking place in the method of the invention for communication between the members of the social media network.

FIG. 1B is continuation of FIG. 1A.

### DETAILED DESCRIPTION OF THE INVENTION

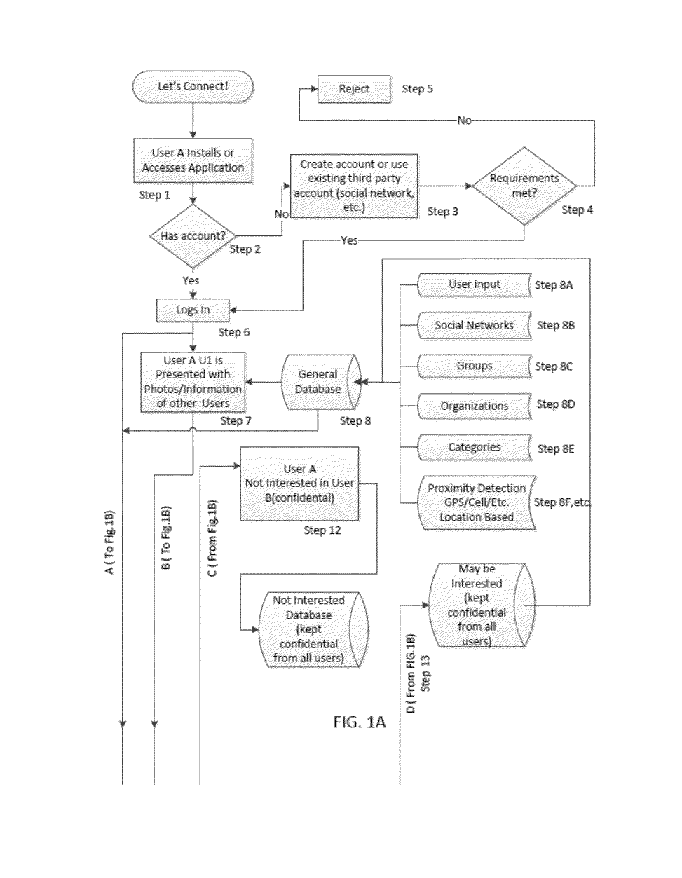

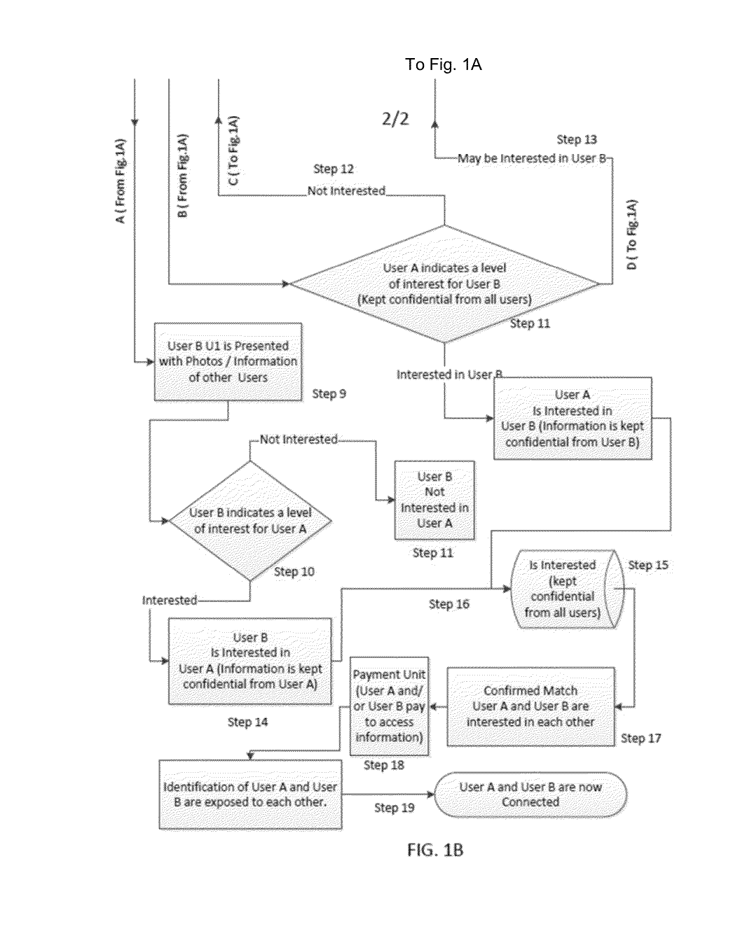

The invention is described below in application to a social group of people, i.e., to a social media of individuals who want to find a person or persons having the same level of interests. It is understood that this description and the specific example given below with reference to FIGS. 1A and 1B do not limit the scope of application of the invention and that any changes and modifications are possible without departure from the scope of the invention. FIG. 1A is a flow-chart that illustrates the sequence of events taking place in the method of the invention for communication between the members of the social media network. FIG. 1B is continuation of FIG. 1A.

In the following example, if a user, e.g., a searching person (hereinafter referred to as user UA1) is looking for a person, e.g., of the same interests, first he/she submits an application for acceptation to the social network of the invention (hereinafter referred to as a “system”), e.g., through the Internet, provided that the network has been preliminarily installed in the world net under its specific registered name, e.g., “Let's Connect”. Once subscribed to “Let's Connect, user the UA1 may access the system (Step 1).

Once entered the system, the user AU1 is asked: “Have an account?” (Step 2). If the answer is “No”, the user AU1 is requested to create an account or use an existing third party account (social network, etc.) (Step 3). In the next step (Step 4) it is checked if the credentials of the user AU1 satisfy the requirements of the system, and if the answer is “No”, the application is rejected (Step 5). An example of a reason for which the applicant may be rejected is the applicant's age, e.g., the applicant is below the age of 14, the applicant has unacceptable criminal records, or the like.

If the answers to the questions of Step 2 or Step 4 are positive, the user AU1 is logged in into the system (Step 6) and is presented with a limited information, e.g., only photos and age of other users of the social network. This information can be obtained from the general database (Step 7) into which is can be entered in different ways (step 8), e.g., the data can be inputted by the users of the system (Step 8A), or obtained from various social networks (Step 8B), group (Step 8C), organization (Step 8D), categories (Step 8E), location (step 8F), etc. (FIG. 1A). It is understood that among other things the information loaded into the general database at step 8 also includes the picture and data about user AU1 and a user BU1, who at this stage is assumed as a potential contact or match of the user AU1.

Thus, the aforementioned data can be loaded into the general database from the “Let's Connect” network, as well as from external sources. However, although the pictures contains in this data are pictures of real people, the remaining information should be limited to the extent that it would not possible to identify the users. In other words, the data cannot include real names and last names, e-mails, residence addresses, or any other information that allows direct contact between the users.

Simultaneously with the user AU1, the same information about the other users as described above is sent at Step 9 from the general database to the person being sought (hereinafter referred to as the user BU1) (FIG. 1B). In Step 10 the user BU1 indicates whether he/she is interested in one or more persons contained in the information obtained from the user AU1. If he/she is not interested, then this chain of events of the process of the invention is completed at Step 11. However, none the users is aware of the fact that at this stage the user BU1 has no interest in anybody including the user AU1.

Upon receipt of the information from the general data base (Step 7, FIG. 1A), the user AU1 indicates the level of interest in one or several users (Step 11, FIG. 1B), including the user BU1, and if he/she is not interest, then this decision is sent through Step 12 to a not-interested database, where it is kept confidential, so nobody is hurt by the rejection.

If, on the other hand, the user AU1 indicates some level of interest in the selected user or users, then his/her decision is sent at Step 13 to the general database but still remains confidential (FIG. 1A). The level of interest may be graded, e.g., on a scale of 1 to 10, where 10 corresponds to “very interested” and 1 corresponds to “not interested”. The grade is selected from an interest gradation unit.

If at Step 10 the user BU1 indicates a level of interest (Step 14) in the selected user AU1, which fact, while being still unknown to all users (Step 15), is sent to an “is-interested” database. If at Step 10 the user BU1 expresses an interest in a user AU1, of which the user AU1 is yet unaware, the system sends this decision to the same “is-interested” database (Step 16). The level of interest may be graded, e.g., on a scale of 1 to 10, where 10 corresponds to “very interested” and 1 corresponds to “not interested”.

Thus, now the “is-interested” database contains the level of interest of the user AU1 in the user BU1 (let us assume that this level is “level 8”) and the level of interest of the user BU1 in the user AU1 (let us assume that this level is “level 9”). Until now neither user AU1 nor user BU1 knows that they independently have chosen each other. Let us also assume that in order to be matched their levels of interests should be higher than a threshold level, e.g., 8 on the aforementioned 10 point scale. In this case, in the examples given above the users AU1 and BU1 are matched (Step 17).

Next each of the users AU1 and BU1 is informed that someone is interested in him/her, and if they both agree to be connected and exposed to each other, this is done at the Step 18 [FIG. 1B].

Alternatively, the identification and interconnection of both users can be carried out through a mating fee procedure (Step 19).

The above example relates to the case when a person who searches an individual of common interests, location, profession, etc. is initially not a member of the social network and in order to participate in the network activity has to open an account with the network. However, it is understood that the searching person may already be a network member and that the procedure may start from Step 6 in the flowchart of FIG. 1A.

Alternatively, the method of the invention covers the case when both users AU1 and BU1 are not member of the network and both pass through the Steps from Step 1 to Step 18.

Thus, it is understood that although the invention has been shown and described with reference to specific examples, these examples should not be construed as limiting the areas of application of the invention and that any changes and modifications are possible provided that these changes and modifications do not depart from the scope of the attached patent claims.

The novelty of the social media network and the method of user's communication according to the invention resides in that the application allows for the individual user to be able to maintain anonymity while expressing various levels of interest concerning the user's selected party, and to not be too intrusive upon the selected individuals within their inner and extended network, group, or other. The objective is to establish a safe, fun, and casual social network and mobile environment where the user can enjoy anonymity until a mutual and positive connection is confirmed between the user and another party, and to be able to reach out, communicate, and connect with their inner and extended social network, group, or other.

1. A method of finding members of the social media network having the same interests comprising the steps of:
(a) providing the social media network with an account for the members, a general database, “not-interested” database, “may-be-interested” database, “is-interested” database, and a level of interest gradation unit, the social media network being preliminarily installed in the world net, the general database containing a limited information about the members of the social media network, the limited information making it impossible to identify the member;
(b) checking if a person who is logging into the social media network has an account with the social media network;
(c) checking through the account if the person satisfies the membership requirements;
(d) loading into the general database of the social media network a limited information about the person who was accepted as a member to the social media network;
(e) presenting to the person who was accepted as a member the limited information about the other members;
(f) using said limited information by a person accepted as a member to the social media network for finding another member who has the same interests;
(g) keeping the fact of searching confidential from all other members of the social network so that a member being sought is not aware of the search;
(h) placing the “not-interested” information into the “not-interested” database, if the searching person is not interested in any of other members and keeping the “not-interested” information confidential;
(i) choosing a level of interest from the interest gradation unit if the searching person is interested in another member of the social network and establishing a minimal difference of the grades at which the searching person and the person being sought are considered matched, the level of interest being kept confidential;
(j) sending the chosen level of information to the general database and to the “may-be-interested” database where it is kept confidential from other members;
(k) passing the person being sought through the steps (b) through (j) while keeping the procedures confidential for the searching person as well as for the other members of the social network;
(l) comparing the level of interest of the searching person with the level of interest of the person being sought if the person being sought independently expresses his/her interest in the searching person, both persons still being unaware of the mutual interest, and the levels of interest being places into the “is-interested” database;
(m) asking the searching person and the person being sought if they both agree to be exposed to each other, if the minimal difference of the grades is achieved; and
(n) exposing the searching person to the person being sought if both these persons agree to be connected.

2. The method of claim 1, wherein the limited information comprises a photo and age of a member of the social network.

3. The method of claim 1, wherein the level of interest is evaluated on a 10 point scale.

4. The method of claim 2, wherein the level of interest is evaluated on a 10 point scale.

5. The method of claim 1, further comprising a step (o) of a mating fee procedure between the steps (m) and (n).

6. The method of claim 2, further comprising a step (o) of a mating fee procedure between the steps (m) and (n).

7. The method of claim 3, further comprising a step (o) of a mating fee procedure between the steps (m) and (n).

8. The method of claim 4, further comprising a step (o) of a mating fee procedure between the steps (m) and (n).

9. A method of communication between the users of the social media network having the same interests comprising the steps of:
(a) providing the social media network for users having account with the social media network;
(b) presenting to a user, who is searching among other members a person of the same interest, a limited information about the other users, the limited information making it impossible to identify a user;
(c) keeping the fact of searching confidential from all other users of the social network;
(d) choosing a level of interest if the user who is searching is interested in the person of the same interest and establishing a minimal difference of the grades at which the user who is searching and the person of the same interest are considered matched, the level of interest being kept confidential;
(e) passing the person of the same interest through the steps (b) through (d) while keeping the procedures confidential for the user who is searching as well as for the other users of the social network;
(f) comparing the level of interest of the user who is searching with the level of interest of the person of the same interest if the person of the same interest of the social network who is sought independently expresses his/her interest in the user who is searching, both users still being unaware of the mutual interest;
(g) asking the user who is searching and the person of the same interest if they both agree to be exposed to each other, if the levels of their interest coincide; and
(h) exposing the user who is searching to the person of the same interest if both agree to be connected.

10. The method of claim 9, wherein the limited information comprises a photo and age of a member of the social network.

11. The method of claim 9, wherein the level of interest is evaluated on a 10 point scale.

12. The method of claim 10, wherein the level of interest is evaluated on a 10 point scale.

13. The method of claim 9, further comprising a step (i) of a mating fee procedure between the steps (g) and (h).

14. The method of claim 10, further comprising a step (i) of a mating fee procedure between the steps (g) and (h).

15. The method of claim 11, further comprising a step (i) of a mating fee procedure between the steps (g) and (h).

16. The method of claim 12, further comprising a step (i) of a mating fee procedure between the steps (g) and (h).
